(19) United States
(12) Patent Application Publication
(10) Pub. No.: US 2006/0072644 A1
(43) Pub. Date: Apr. 6, 2006

(54) Rapid sensing clinical thermometer embedded in nipple

(76) Inventor: Yung-Ku Lee, Taichung (TW)

Correspondence Address: Yung-Ku Lee, 235 Chung-Ho, Box 8-24, Taipei, TW

(21) Appl. No.: 10/958,877

(22) Filed: Oct. 6, 2004

(51) Int. Cl. G01K 1/08; G01K 13/00; G01K 1/00

(52) U.S. Cl. 374/151; 374/208

(57) ABSTRACT

A rapid sensing clinical thermometer embedded in a nipple comprises a mask; a nipple head installed at an end of the mask; a control element installed at the mask; a temperature detector installed in the nipple head; measured temperatures being transferred to the control element; a probe in the temperature detector; a part of the probe exposes out of the nipple head. The temperature detector includes the probe, a temperature sensor; and a sensing wire. The probe is made of heat conductive metal. The nipple head is made of soft rubber material or silicon. One end of the nipple head has a penetrated through hole for receiving the probe. The probe is a cylinder with one sealing end and one opening end and an interior of the probe is formed with a receiving space.

### FIELD OF THE INVENTION

The present invention relates to clinical thermometers, and particularly to a rapid sensing clinical thermometer embedded in a nipple, when a baby holds the rapid sensing clinical thermometer of the present invention in mouth. The tongue of the baby will touch the nipple head since the temperature sensor exposes out of the nipple head. The measured temperature will be transferred to the control element rapidly and then the value of the temperature will display on the display screen.

### BACKGROUND OF THE INVENTION

There are many kinds of nipple type clinical thermometers are used currently. However they have the defects of long measuring time, or have too complicated structures, or are too expensive, or heat dispersion in transfer so as to have great errors. If it is desired to have a correct measuring value, a longer time is required to achieve heat equilibrium.

In the prior art nipple type clinical thermometer, a temperature sensor is used. Generally, the temperature sensor is made of silicon which is not a preferred heat conduction material. In measuring, the heat from mouth must be transferred through the wall for a longer time and thus a great error is induced.

For example, referring to FIG. 6, a current used nipple type clinical thermometer is illustrated. A temperature sensor 12 is placed at a front end 11 of a nipple head 1. A rear end of the temperature sensor 12 is connected to a sensing wire 13. In measurement, the nipple head 1 is held within the mouth. The heat of the mouth will be firstly transferred through the front end 11 of the nipple head 1 and then to the temperature sensor 12 and then the temperature is transferred to the internal electronic element in the sensing wire 13. After calculation, the temperature value is displayed on the display screen. Generally, the nipple head 1 is made of silicon, which is thick and is not a preferred heat conduction object. Thereby the time for achieving heat equilibrium is long, at least 3 minutes, ever a more longer time is required.

In another prior art, a fixing element in the inner wall of the nipple head, another fixing element and a temperature transducer at the outer sides of the nipple head are clamped together. Too many elements are assembled within a very small space. The assembly process is long, and inconvenient. Special work tools are necessary. Thus the yield ratio is low and cost is high. In the clamping process, if the clamping force can no be well controlled, the temperature transducer will be destroyed. If the clamping force is slight, a contact element will not effectively contact the temperature transducer so as to effect the transfer of the temperature. Thereby there are many technological problems induced in this prior art, which are necessary to be resolved.

### SUMMARY OF THE INVENTION

Accordingly, the primary object of the present invention is to provide a rapid sensing clinical thermometer embedded in a nipple, when a baby holds the rapid sensing clinical thermometer of the present invention in mouth. The tongue of the baby will touch the nipple head since the temperature sensor exposes out of the nipple head. The measured temperature will be transferred to the control element rapidly and then the value of the temperature will display on the display screen.

To achieve above object, the present invention provides a rapid sensing clinical thermometer embedded in a nipple which comprises a mask; a nipple head installed at an end of the mask; a control element installed at the mask; a temperature detector installed in the nipple head; measured temperatures being transferred to the control element; a probe in the temperature detector; a part of the probe exposes out of the nipple head. The temperature detector includes the probe, a temperature sensor; and a sensing wire. The probe is made of heat conductive metal. The nipple head is made of soft rubber material or silicon. One end of the nipple head has a penetrated through hole for receiving the probe. The probe is a cylinder with one sealing end and one opening end and an interior of the probe is formed with a receiving space.

The various objects and advantages of the present invention will be more readily understood from the following detailed description when read in conjunction with the appended drawing.

### BRIEF DESCRIPTION OF THE DRAWINGS

FIG. 1 is a schematic cross view of the rapid sensing clinical thermometer embedded in a nipple of the present invention.

FIG. 2 is a perspective view of the rapid sensing clinical thermometer embedded in a nipple of the present invention.

FIG. 3 is a perspective view showing another view of the rapid sensing clinical thermometer embedded in a nipple of the present invention.

FIG. 4 is a schematic view about the application of the present invention.

FIG. 5 is another schematic view showing the application of the present invention.

FIG. 6 is a schematic view about the prior art sensing clinical thermometer embedded in a nipple.

### DETAILED DESCRIPTION OF THE INVENTION

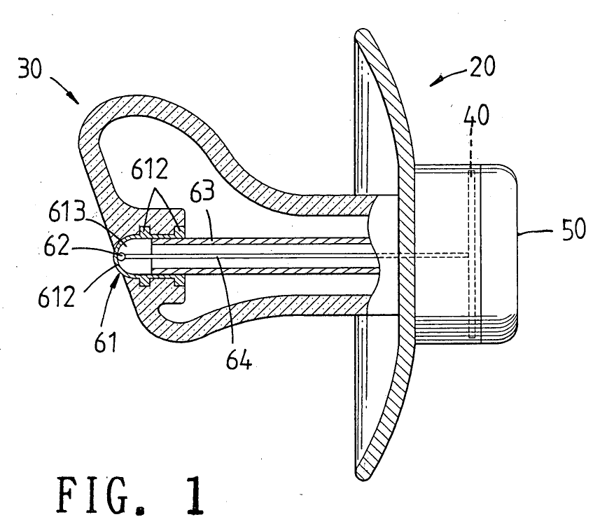

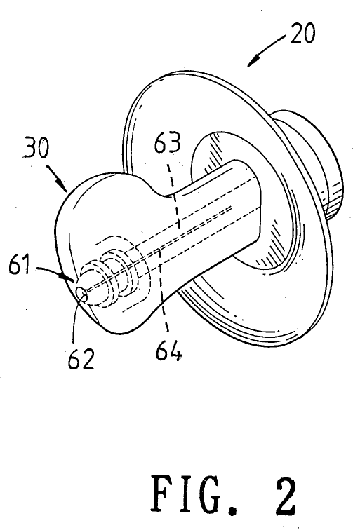

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims. Referring to FIGS. 1 to 3, the rapid sensing clinical thermometer embedded in a nipple of the present invention is illustrated. The present invention has the following elements.

A mask 20 is included.

A nipple head 30 is at a front end of the mask 20.

A control element 40 is installed at a rear end of the mask 20.

A temperature detector is installed in the nipple head 30. The measured temperature is transferred to the control element 40.

A display screen 50 is installed at the rear end of the mask 20. The measured temperature in the control element 40 is calculated and then is displaced on the display screen 50.

The nipple head 30 is made of soft material, silicon is preferably. However this is known in the prior art and thus the detail will not be described herein. The nipple head 30 is hollow. A front end of the nipple head 30 has a penetrating through hole 31 for embedding the temperature sensor.

The temperature detector includes a probe 61, a temperature sensor 162, a soft protecting tube 63 and a sensing wire 64.

The probe 61 is a metal cylinder with a sealing end 611 at one end thereof. A part of an outer side of the sealing end 611 protrudes out of the nipple head 30 for sensing temperature. A periphery of the probe 61 has two annular projections 612 which are just embedded into the through hole 31 of the nipple head 30 so as to secure the probe 61 to the nipple head 30 firmly. A front end of the probe 61 has a receiving space 613 for receiving or adhering a temperature sensor 62 in an inner side thereof. Thus the probe 61 can measure an accurate temperature and then the measured temperature is transferred to the temperature sensor 62.

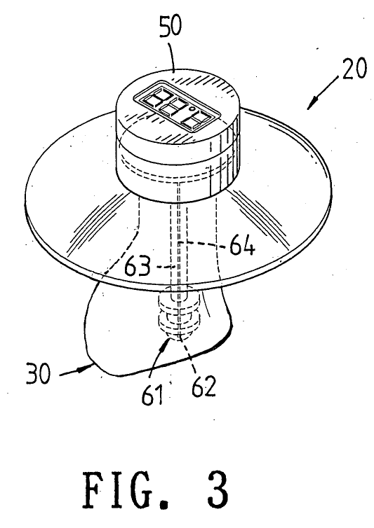

The temperature sensor 62 is connected to a sensing wire 64. The sensing wire 64 is further connected to the control element 40. The temperature from the temperature sensor 62 is transferred to the control element 40 through the sensing wire 64. The control element 40 converts the temperature sensor 62 into temperature value rapidly and then is display on the display screen 50 (referring to FIG. 3).

Besides the soft protecting tube 63 encloses the sensing wire 64. One end of the protecting tube 63 is placed in the probe 61 and another end thereof is connected to the control element 40.

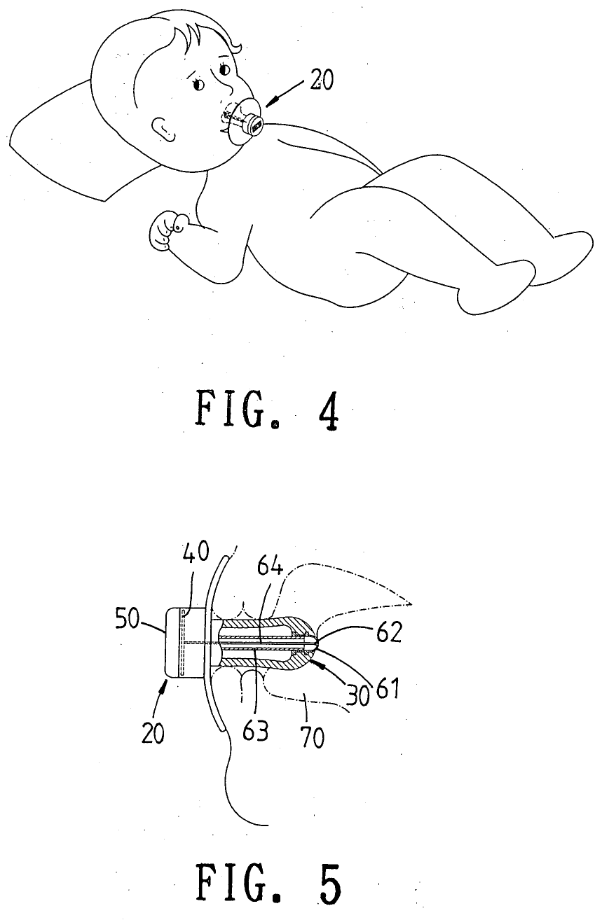

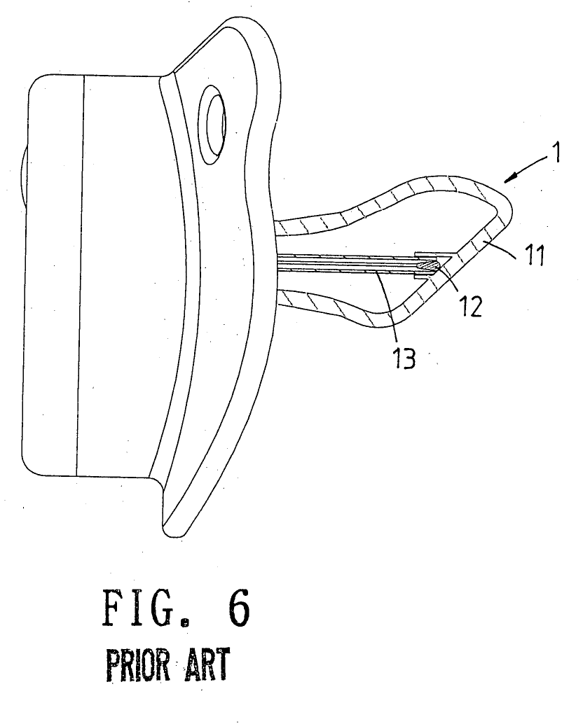

Referring to FIGS. 4 and 5, the rapid sensing clinical thermometer embedded in a nipple of the present invention is suitable for babies. The body temperature of a baby can be got through the rapid sensing clinical thermometer of the present invention, while the baby does not sense the measuring action. When a baby holds the rapid sensing clinical thermometer the present invention in mouth. The tongue 70 of the baby will touch the nipple head 30 since the temperature sensor 62 exposes out of the nipple head 30. The measured temperature will be transferred to the control element 40 rapidly and then the value of the temperature will display on the display screen 50.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A rapid sensing clinical thermometer embedded in a nipple comprising:
a mask;
a nipple head installed at of the mask;
a control element installed at the mask;
a temperature detector installed in the nipple head; measured temperatures being transferred to the control element;
a probe in the temperature detector; a part of the probe exposes out of the nipple head.

2. The rapid sensing clinical thermometer embedded in a nipple as claimed in claim 1, wherein the temperature detector includes the probe, a temperature sensor; and a sensing wire.

3. The rapid sensing clinical thermometer embedded in a nipple as claimed in claim 1, wherein the probe is made of heat conductive metal.

4. The rapid sensing clinical thermometer embedded in a nipple as claimed in claim 1, wherein the nipple head is made of soft rubber material.

5. The rapid sensing clinical thermometer embedded in a nipple as claimed in claim 1, wherein the nipple head is made of silicon.

6. The rapid sensing clinical thermometer embedded in a nipple as claimed in claim 1, wherein one end of the nipple head has a penetrated through hole for receiving the probe.

7. The rapid sensing clinical thermometer embedded in a nipple as claimed in claim 1, wherein the probe is a cylinder with one sealing end and one opening end and an interior of the probe is formed with a receiving space.

8. The rapid sensing clinical thermometer embedded in a nipple as claimed in claim 1, wherein an outer periphery of the sensing wire is protected by a soft tube.

9. The rapid sensing clinical thermometer embedded in a nipple as claimed in claim 1, further comprising:
a display screen installed at the mask; the measured temperature in the control element is calculated and then is displaced on the display screen

10. The rapid sensing clinical thermometer embedded in a nipple as claimed in claim 1, wherein a periphery of the probe has two annular projections which are just embedded into the through hole of the nipple head so as to secure the probe to the nipple head firmly.
